(19) United States
(12) Patent Application Publication
(10) Pub. No.: US 2026/0177728 A1
(43) Pub. Date: Jun. 25, 2026

(54) VARIABLE APERTURE MODULE, IMAGING LENS ASSEMBLY MODULE AND ELECTRONIC DEVICE

(71) Applicant: LARGAN PRECISION CO., LTD., Taichung City (TW)

(72) Inventors: Zheng-Zhi HONG, Taichung City (TW); Chen-Wei FAN, Taichung City (TW)

(21) Appl. No.: 19/422,716

(22) Filed: Dec. 17, 2025

Related U.S. Application Data
(60) Provisional application No. 63/738,684, filed on Dec. 24, 2024.

(51) Int. Cl. G02B 5/00

(52) U.S. Cl. CPC G02B 5/005

(57) ABSTRACT

A variable aperture module includes a blade set, a fixing portion, a rotating portion, a driving unit and a position detecting unit. The blade set includes a plurality of blades, which form a light through hole. The rotating portion is for driving each of the blades to rotate so as to adjust a size of the light through hole. The driving unit is configured for driving the rotating portion to rotate, and includes a first magnet element and a first driving coil. The first driving coil is configured to generate a driving force with the first magnet element. The position detecting unit includes a first detecting magnet, a second detecting magnet, a first hall element and a second hall element. When any of the first hall element and the second hall element detects a magnetic field, the position detecting unit outputs a position signal.

### RELATED APPLICATIONS

This application claims priority to U.S. Provisional Application Ser. No. 63/738,684, filed Dec. 24, 2024, which is herein incorporated by reference.

### BACKGROUND

### Technical Field

The present disclosure relates to a variable aperture module and an imaging lens assembly module. More particularly, the present disclosure relates to a variable aperture module and an imaging lens assembly module applicable to portable electronic devices.

### Description of Related Art

In recent years, portable electronic devices have developed rapidly. For example, intelligent electronic devices and tablets have been filled in the lives of modern people, and camera modules and imaging lens assembly modules mounted on portable electronic devices have also prospered. However, as technology advances, the quality requirements of the variable aperture module are becoming higher and higher. Therefore, a variable aperture module, which can control the dimension of the light through hole, needs to be developed.

### SUMMARY

According to one aspect of the present disclosure, a variable aperture module includes a blade set, a fixing portion, a rotating portion, a driving unit and a position detecting unit. The blade set includes a plurality of blades, the blades form a light through hole and a size of the light through hole is adjustable. The rotating portion rotates related to the fixing portion, and is for driving each of the blades to rotate related to the fixing portion so as to adjust the size of the light through hole. The driving unit is configured for driving the rotating portion to rotate, and includes a first magnet element and a first driving coil. The first magnet element is disposed on one of the rotating portion and the fixing portion. The first driving coil is disposed on the other one of the rotating portion and the fixing portion, and is configured to generate a driving force with the first magnet element. The position detecting unit includes a first detecting magnet, a second detecting magnet, a first hall element and a second hall element. The first detecting magnet is disposed on one of the rotating portion and the fixing portion. The second detecting magnet is disposed on one of the rotating portion and the fixing portion. The first hall element corresponds to the first detecting magnet, and is configured to detect a magnetic field of the first detecting magnet. The second hall element corresponds to the second detecting magnet, and is configured to detect a magnetic field of the second detecting magnet. The first hall element and the second hall element are electrically connected to each other. The position detecting unit has an OR gate function, when any of the first hall element and the second hall element detects the magnetic field, the position detecting unit outputs a position signal.

According to another aspect of the present disclosure, a variable aperture module includes a blade set, a fixing portion, a rotating portion, a driving unit, a position detecting unit and a controlling unit. The blade set includes a plurality of blades, the blades form a light through hole and a size of the light through hole is adjustable. The rotating portion rotates related to the fixing portion, and is for driving each of the blades to rotate related to the fixing portion so as to adjust the size of the light through hole. The driving unit is configured for driving the rotating portion to rotate, and includes a first magnet element and a first driving coil. The first magnet element is disposed on one of the rotating portion and the fixing portion. The first driving coil is disposed on the other one of the rotating portion and the fixing portion, and is configured to generate a driving force with the first magnet element. The position detecting unit includes a first detecting magnet, a second detecting magnet, a first hall element and a second hall element. The first detecting magnet is disposed on one of the rotating portion and the fixing portion. The second detecting magnet is disposed on one of the rotating portion and the fixing portion. The first hall element corresponds to the first detecting magnet, and is configured to detect a magnetic field of the first detecting magnet. The second hall element corresponds to the second detecting magnet, and is configured to detect a magnetic field of the second detecting magnet. The controlling unit receives a position signal from the first hall element and a position signal from the second hall element. When any of the first hall element and the second hall element detects the magnetic field, each of the first hall element and the second hall element outputs each of the position signals to the controlling unit, and each of the position signals is calculated via an OR gate function of the controlling unit to generate a position information.

According to another aspect of the present disclosure, a variable aperture module includes a blade set, a fixing portion, a rotating portion, a driving unit and a position detecting unit. The blade set includes a plurality of blades, the blades form a light through hole and a size of the light through hole is adjustable. The rotating portion rotates related to the fixing portion, and is for driving each of the blades to rotate related to the fixing portion so as to adjust the size of the light through hole. The driving unit is configured for driving the rotating portion to rotate, and includes a first magnet element, a second magnet element, a first driving coil and a second driving coil. The first magnet element is disposed on one of the rotating portion and the fixing portion. The second magnet element is disposed on one of the rotating portion and the fixing portion. The first driving coil is disposed on the other one of the rotating portion and the fixing portion, and configured to generate a driving force with the first magnet element. The second driving coil is disposed on the other one of the rotating portion and the fixing portion, and is configured to generate a driving force with the second magnet element. The position detecting unit includes a first hall element and a second hall element. The first hall element corresponds to the first magnet element, and is configured to detect a magnetic field of the first magnet element. The second hall element corresponds to the second magnet element, and is configured to detect a magnetic field of the second magnet element. The first hall element and the second hall element are electrically connected to each other. The position detecting unit has an OR gate function. When any of the first hall element and the second hall element detects the magnetic field, the position detecting unit outputs a position signal.

According to another aspect of the present disclosure, a variable aperture module includes a blade set, a fixing portion, a rotating portion, a driving unit, a position detecting unit and a controlling unit. The blade set includes a plurality of blades, the blades form a light through hole and a size of the light through hole is adjustable. The rotating portion rotates related to the fixing portion, and is for driving each of the blades to rotate related to the fixing portion so as to adjust the size of the light through hole. The driving unit is configured for driving the rotating portion to rotate, and includes a first magnet element, a second magnet element, a first driving coil and a second driving coil. The first magnet element is disposed on one of the rotating portion and the fixing portion. The second magnet element is disposed on one of the rotating portion and the fixing portion. The first driving coil is disposed on the other one of the rotating portion and the fixing portion, and configured to generate a driving force with the first magnet element. The second driving coil is disposed on the other one of the rotating portion and the fixing portion, and is configured to generate a driving force with the second magnet element. The position detecting unit includes a first hall element and a second hall element. The first hall element corresponds to the first magnet element, and is configured to detect a magnetic field of the first magnet element. The second hall element corresponds to the second magnet element, and is configured to detect a magnetic field of the second magnet element. The controlling unit receives a position signal from the first hall element and a position signal from the second hall element. When any of the first hall element and the second hall element detects the magnetic field, each of the first hall element and the second hall element outputs each of the position signals to the controlling unit, and each of the position signals is calculated via an OR gate function of the controlling unit to generate a position information.

According to another aspect of the present disclosure, an imaging lens assembly module includes the variable aperture module of the aforementioned aspect.

According to another aspect of the present disclosure, an electronic device includes the imaging lens assembly module of the aforementioned aspect.

### BRIEF DESCRIPTION OF THE DRAWINGS

The present disclosure can be more fully understood by reading the following detailed description of the embodiment, with reference made to the accompanying drawings as follows:

FIG. 1A is a three-dimensional schematic view of an imaging lens assembly module according to the 1st embodiment of the present disclosure.

FIG. 1B is an exploded view of the variable aperture module according to the 1st embodiment in FIG. 1A.

FIG. 1C is another exploded view of the variable aperture module according to the 1st embodiment in FIG. 1A.

FIG. 1D is a schematic view of the flexible printed circuit board according to the 1st embodiment in FIG. 1C.

FIG. 1E is a schematic view of the driving unit, the position detecting unit, the computing unit and the controlling unit according to the 1st embodiment in FIG. 1A

FIG. 1F is a schematic view of the flexible printed circuit board according to the 1st example of the 1st embodiment of the present disclosure.

FIG. 1G is a schematic view of the position detecting unit according to the 1st example of the 1st embodiment of the present disclosure.

FIG. 1H is a schematic view of the flexible printed circuit board according to the 2nd example of the 1st embodiment of the present disclosure.

FIG. 1I is a schematic view of the position detecting unit according to the 2nd example of the 1st embodiment of the present disclosure.

FIG. 2A is a three-dimensional schematic view of an imaging lens assembly module according to the 2nd embodiment of the present disclosure.

FIG. 2B is an exploded view of the variable aperture module according to the 2nd embodiment in FIG. 2A.

FIG. 2C is another exploded view of the variable aperture module according to the 2nd embodiment in FIG. 2A.

FIG. 3A is a schematic view of an electronic device according to the 3rd embodiment of the present disclosure.

FIG. 3B is another schematic view of the electronic device according to the 3rd embodiment in FIG. 3A.

FIG. 3C is a schematic view of an image captured via the electronic device according to the 3rd embodiment in FIG. 3A.

FIG. 3D is another schematic view of an image captured via the electronic device according to the 3rd embodiment in FIG. 3A.

FIG. 3E is still another schematic view of an image captured via the electronic device according to the 3rd embodiment in FIG. 3A.

FIG. 4 is a schematic view of an electronic device according to the 4th embodiment of the present disclosure.

### DETAILED DESCRIPTION

The present disclosure provides a variable aperture module, and the variable aperture module includes a blade set, a fixing portion, a rotating portion, a driving unit and a position detecting unit. The blade set includes a plurality of blades, the blades form a light through hole and a size of the light through hole is adjustable. The rotating portion rotates related to the fixing portion, and is for driving each of the blades to rotate related to the fixing portion so as to adjust the size of the light through hole. The driving unit is configured for driving the rotating portion to rotate, and includes a first magnet element and a first driving coil. The first magnet element is disposed on one of the rotating portion and the fixing portion. The first driving coil is disposed on the other one of the rotating portion and the fixing portion, and is configured to generate a driving force with the first magnet element. The position detecting unit includes a first detecting magnet, a second detecting magnet, a first hall element and a second hall element. The first detecting magnet is disposed on one of the rotating portion and the fixing portion. The second detecting magnet is disposed on one of the rotating portion and the fixing portion. The first hall element corresponds to the first detecting magnet, and is configured to detect a magnetic field of the first detecting magnet. The second hall element corresponds to the second detecting magnet, and is configured to detect a magnetic field of the second detecting magnet. The first hall element and the second hall element are electrically connected to each other. The position detecting unit has an OR gate function, when any of the first hall element and the second hall element detects the magnetic field, the position detecting unit outputs a position signal. In detail, when any one of the first hall element and the second hall element detects a displacement of the magnet, the position signal is outputted to a controlling unit, and the controlling unit calculates a new target position and controls the driving unit to drive the rotating portion rotating to the new target position. Therefore, it is favorable for increasing the detecting accuracy of the variable aperture module.

Specifically, when one of the hall elements is failed, other hall elements can still provide the signal. Therefore, it is favorable for ensuring the stability of the variable aperture module. Further, by outputting the signals in parallel, it is favorable for reducing the noise interference. Furthermore, a number of the hall elements can be more than two.

The first hall element and the second hall element are connected in parallel. In detail, the same pins are conductively connected to each other in parallel; when the output pins of the two hall elements are connected in parallel, the output voltage level turns to low while any of the two hall elements detects the magnetic field, and the entire output voltage becomes low level so as to realize the OR gate function. Moreover, a pull-up resistor can be added to generate high level. In detail, the hall element can be open-drain type or open-collector type, but the present disclosure is not limited thereto.

The first detecting magnet and the second detecting magnet are disposed circular symmetrically. Therefore, it is favorable for preventing the magnetic fields of the two detecting magnets from interfering with the hall elements.

The first hall element and the second hall element are disposed circular symmetrically. Therefore, the relative distance between the two hall elements and the magnets can be the same so as to synchronize the detecting magnetic field.

The variable aperture module further includes a flexible printed circuit board, the first driving coil is disposed on the other one of the fixing portion and the rotating portion via the flexible printed circuit board, and the flexible printed circuit board supplies power to the first driving coil, the first hall element and the second hall element simultaneously. Therefore, it is favorable for reducing the volume of the circuit board.

The present disclosure provides a variable aperture module, and the variable aperture module includes a blade set, a fixing portion, a rotating portion, a driving unit, a position detecting unit and a controlling unit. The blade set includes a plurality of blades, the blades form a light through hole and a size of the light through hole is adjustable. The rotating portion rotates related to the fixing portion, and is for driving each of the blades to rotate related to the fixing portion so as to adjust the size of the light through hole. The driving unit is configured for driving the rotating portion to rotate, and includes a first magnet element and a first driving coil. The first magnet element is disposed on one of the rotating portion and the fixing portion. The first driving coil is disposed on the other one of the rotating portion and the fixing portion, and is configured to generate a driving force with the first magnet element. The position detecting unit includes a first detecting magnet, a second detecting magnet, a first hall element and a second hall element. The first detecting magnet is disposed on one of the rotating portion and the fixing portion. The second detecting magnet is disposed on one of the rotating portion and the fixing portion. The first hall element corresponds to the first detecting magnet, and is configured to detect a magnetic field of the first detecting magnet. The second hall element corresponds to the second detecting magnet, and is configured to detect a magnetic field of the second detecting magnet. The controlling unit receives a position signal from the first hall element and a position signal from the second hall element. When any of the first hall element and the second hall element detects the magnetic field, each of the first hall element and the second hall element outputs each of the position signals to the controlling unit, and each of the position signals is calculated via an OR gate function of the controlling unit to generate a position information.

In detail, the logic OR gate function can also be achieved by the controlling unit. The controlling unit can include a Microcontroller Unit (MCU) or other signal processing components, and the controlling unit receives and processes the position signals from the two hall elements, respectively. When the controlling unit receives the position signal from any one of the hall elements, the controlling unit can compute the position signal and output a new target position to the driving unit. It is favorable for accelerating a response speed of the variable aperture module. Moreover, when multiple hall elements output the position signals simultaneously, the controlling unit can combine the position signals of the hall elements and perform a weighted average so as to increase the detecting accuracy, reliability and stability.

The first detecting magnet and the second detecting magnet are disposed circular symmetrically. Therefore, it is favorable for preventing the magnetic fields of the two magnets from interfering with the hall elements.

The first hall element and the second hall element are disposed circular symmetrically. Therefore, the relative distance between the two hall elements and the detecting magnets can be the same so as to synchronize the detecting magnetic field.

The variable aperture module further includes a flexible printed circuit board, the first driving coil is disposed on the other one of the fixing portion and the rotating portion via the flexible printed circuit board, and the flexible printed circuit board supplies power to the first driving coil, the first hall element and the second hall element simultaneously. Therefore, it is favorable for reducing the volume of the circuit board.

The present disclosure provides a variable aperture module, and the variable aperture module includes a blade set, a fixing portion, a rotating portion, a driving unit and a position detecting unit. The blade set includes a plurality of blades, the blades form a light through hole and a size of the light through hole is adjustable. The rotating portion rotates related to the fixing portion, and is for driving each of the blades to rotate related to the fixing portion so as to adjust the size of the light through hole. The driving unit is configured for driving the rotating portion to rotate, and includes a first magnet element, a second magnet element, a first driving coil and a second driving coil. The first magnet element is disposed on one of the rotating portion and the fixing portion. The second magnet element is disposed on one of the rotating portion and the fixing portion. The first driving coil is disposed on the other one of the rotating portion and the fixing portion, and configured to generate a driving force with the first magnet element. The second driving coil is disposed on the other one of the rotating portion and the fixing portion, and is configured to generate a driving force with the second magnet element. The position detecting unit includes a first hall element and a second hall element. The first hall element corresponds to the first magnet element, and is configured to detect a magnetic field of the first magnet element. The second hall element corresponds to the second magnet element, and is configured to detect a magnetic field of the second magnet element. The first hall element and the second hall element are electrically connected to each other. The position detecting unit has an OR gate function. When any of the first hall element and the second hall element detects the magnetic field, the position detecting unit outputs a position signal.

Specifically, the magnet elements can be the driving magnet and the detecting magnet at the same time, when any one of the first hall element and the second hall element detects a displacement of the magnet, a position signal is outputted to the controlling unit, and the controlling unit computes a new target position, and drives the driving unit to drive the rotating portion to rotate to the new target position. Therefore, it is favorable for increasing the detecting accuracy of the variable aperture module. When one of the hall elements is failed, other hall elements can still provide the signal. Therefore, it is favorable for ensuring the stability of the variable aperture module. Further, by outputting the signals in parallel, it is favorable for reducing the noise interference. Furthermore, a number of the hall elements can be more than two.

The first hall element and the second hall element are connected in parallel.

The first magnet element and the second magnet element are disposed circular symmetrically, and the first driving coil and the second driving coil are disposed circular symmetrically. Therefore, it is favorable for balancing a force for driving the rotating portion. Moreover, the magnet element can have four polarities. Thus, it is favorable for increasing the magnetic field stability.

The first driving coil and the second driving coil provide a rotating torque for the rotating portion.

The first hall element and the second hall element are disposed circular symmetrically. Therefore, the relative distance between the two hall elements and the magnets can be the same so as to synchronize the detecting magnetic field.

The variable aperture module further includes a flexible printed circuit board, the first driving coil is disposed on the other one of the fixing portion and the rotating portion via the flexible printed circuit board, and the flexible printed circuit board supplies power to the first driving coil, the second driving coil, the first hall element and the second hall element simultaneously. Therefore, it is favorable for reducing the volume of the circuit board.

The present disclosure provides a variable aperture module, and the variable aperture module includes a blade set, a fixing portion, a rotating portion, a driving unit, a position detecting unit and a controlling unit. The blade set includes a plurality of blades, the blades form a light through hole and a size of the light through hole is adjustable. The rotating portion rotates related to the fixing portion, and is for driving each of the blades to rotate related to the fixing portion so as to adjust the size of the light through hole. The driving unit is configured for driving the rotating portion to rotate, and includes a first magnet element, a second magnet element, a first driving coil and a second driving coil. The first magnet element is disposed on one of the rotating portion and the fixing portion. The second magnet element is disposed on one of the rotating portion and the fixing portion. The first driving coil is disposed on the other one of the rotating portion and the fixing portion, and configured to generate a driving force with the first magnet element. The second driving coil is disposed on the other one of the rotating portion and the fixing portion, and is configured to generate a driving force with the second magnet element. The position detecting unit includes a first hall element and a second hall element. The first hall element corresponds to the first magnet element, and is configured to detect a magnetic field of the first magnet element. The second hall element corresponds to the second magnet element, and is configured to detect a magnetic field of the second magnet element. The controlling unit receives a position signal from the first hall element and a position signal from the second hall element. When any of the first hall element and the second hall element detects the magnetic field, each of the first hall element and the second hall element outputs each of the position signals to the controlling unit, and each of the position signals is calculated via an OR gate function of the controlling unit to generate a position information.

In detail, the OR gate function can also be achieved by the controlling unit. The controlling unit can include a MCU or other signal processing components, and the controlling unit receives and processes the position signals from the two hall elements, respectively. When the controlling unit receives the position signal from any one of the hall elements, the controlling unit can compute the position signal and output a new target position to the driving unit. It is favorable for accelerating a response speed of the variable aperture module. Moreover, when multiple hall elements output the position signals simultaneously, the controlling unit can combine the position signals of the hall elements and perform a weighted average so as to increase the detecting accuracy, reliability and stability.

The first magnet element and the second magnet element are disposed circular symmetrically, and the first driving coil and the second driving coil are disposed circular symmetrically. Therefore, it is favorable for balancing a force for driving the rotating portion. Moreover, the magnet element can have four polarities. Thus, it is favorable for increasing the magnetic field stability.

The first driving coil and the second driving coil provide a rotating torque for the rotating portion.

The first hall element and the second hall element are disposed circular symmetrically. Therefore, the relative distance between the two hall elements and the magnets can be the same so as to synchronize the detecting magnetic field.

The variable aperture module further includes a flexible printed circuit board, the first driving coil is disposed on the other one of the fixing portion and the rotating portion via the flexible printed circuit board, and the flexible printed circuit board supplies power to the first driving coil, the second driving coil, the first hall element and the second hall element simultaneously. Therefore, it is favorable for reducing the volume of the circuit board.

Each of the aforementioned features of the variable aperture module can be utilized in various combinations for achieving the corresponding effects.

The present disclosure provides an imaging lens assembly module, which includes the aforementioned variable aperture module.

The present disclosure provides an electronic device, which includes the aforementioned imaging lens assembly module.

According to the aforementioned embodiment, specific embodiments and examples are provided, and illustrated via figures.

### 1st Embodiment

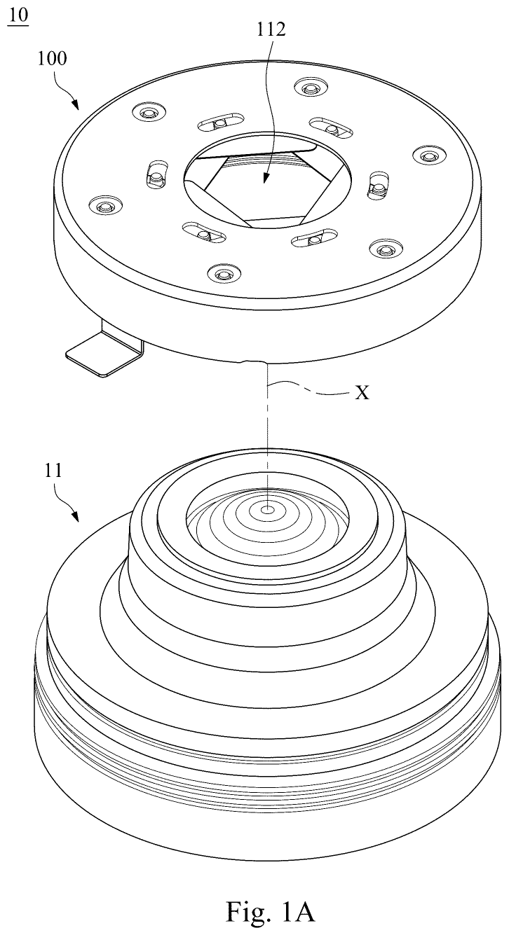

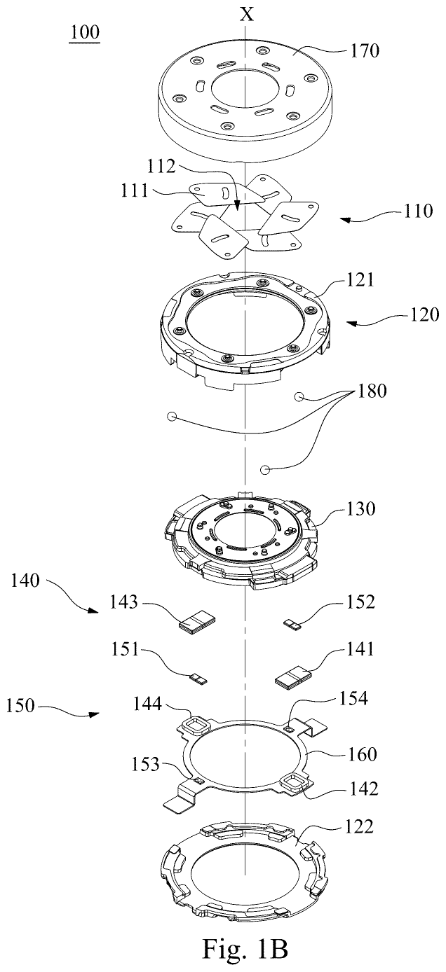

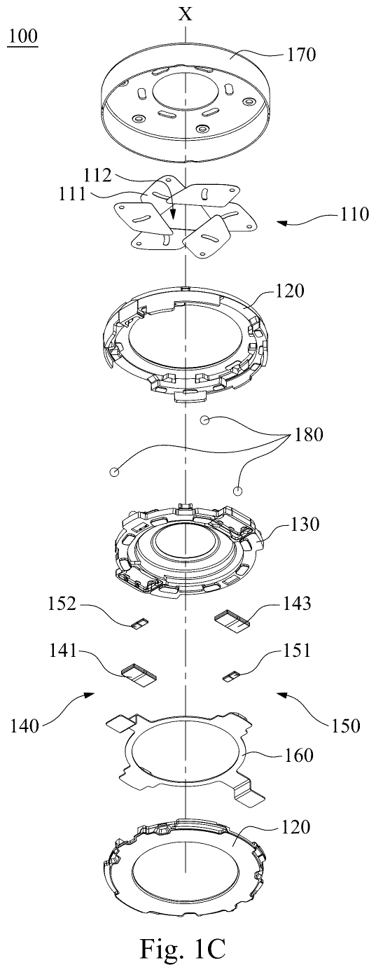

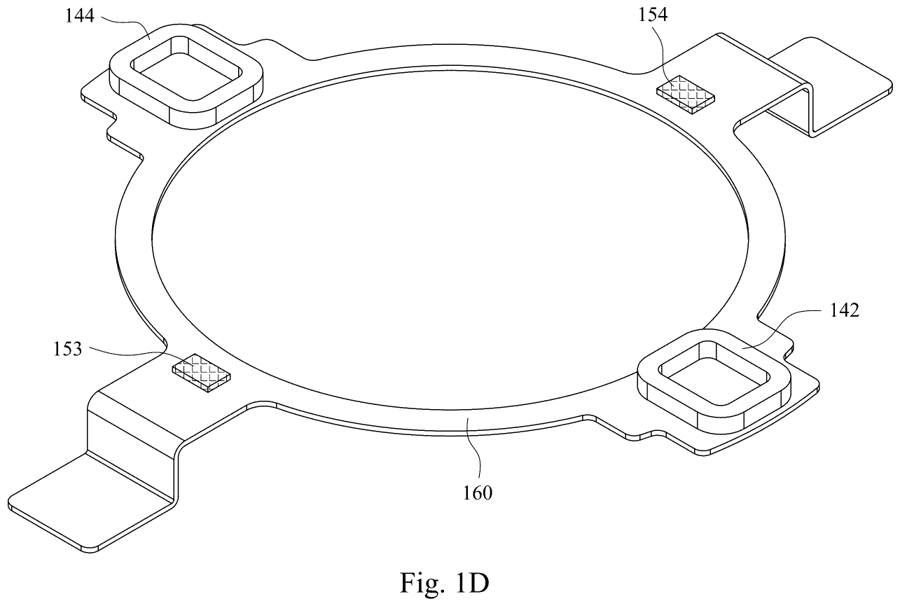

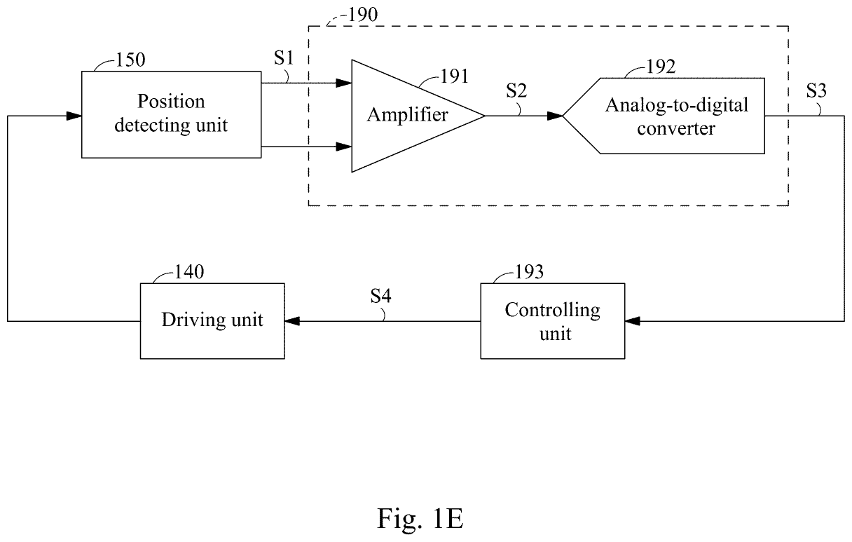

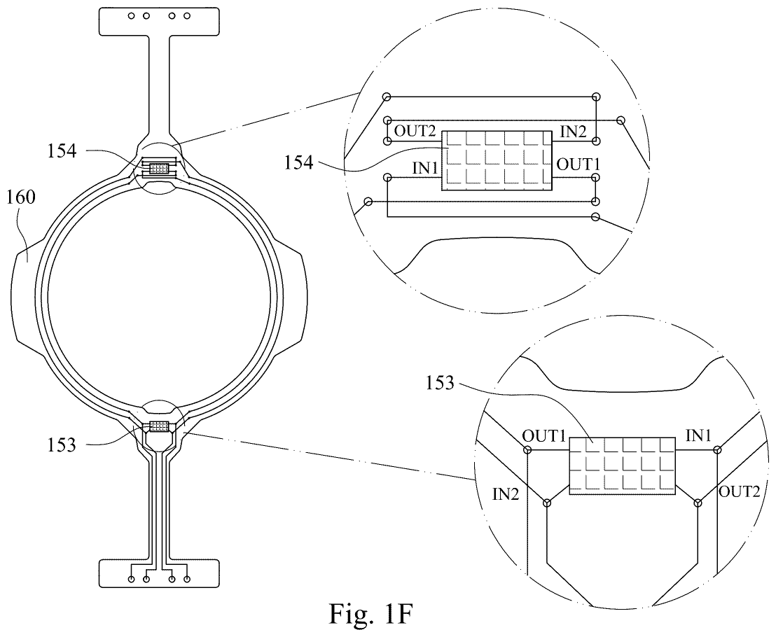

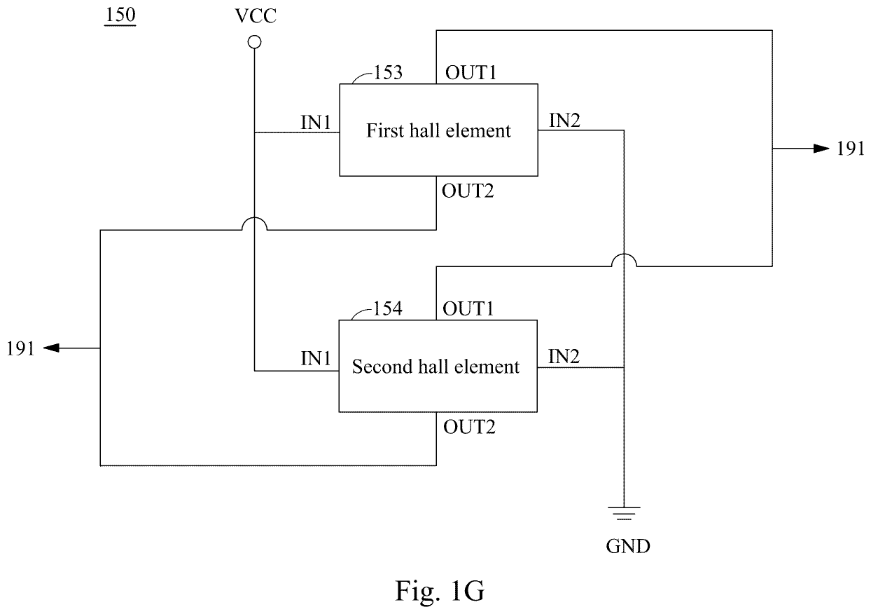

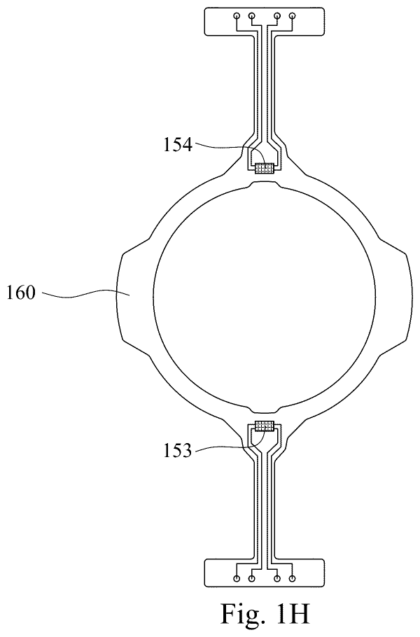

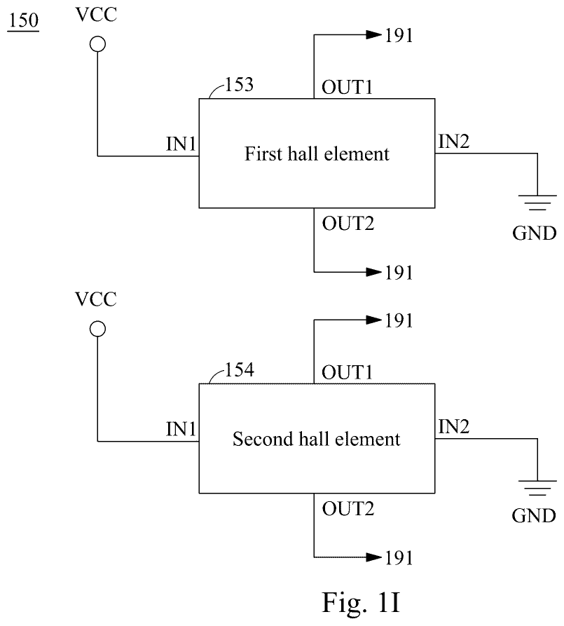

FIG. 1A is a three-dimensional schematic view of an imaging lens assembly module 10 according to the 1st embodiment of the present disclosure. FIG. 1B is an exploded view of the variable aperture module 100 according to the 1st embodiment in FIG. 1A. FIG. 1C is another exploded view of the variable aperture module 100 according to the 1st embodiment in FIG. 1A. An imaging lens assembly module 10 includes a variable aperture module 100 and an imaging lens assembly 11. The variable aperture module 100 includes a blade set 110, a fixing portion 120, a rotating portion 130, a driving unit 140, a position detecting unit 150, a flexible printed circuit board 160, a housing 170 and a rolling element 180. The blade set 110 includes a plurality of blades 111, the blades 111 form a light through hole 112 and a size of the light through hole 112 is adjustable. The fixing portion 120 includes a first fixing element 121 and a second fixing element 122. The rotating portion 130 rotates related to the fixing portion 120, and is for driving each of the blades 111 to rotate related to the fixing portion 120 so as to adjust the size of the light through hole 112. The driving unit 140 is configured for driving the rotating portion 130 to rotate, and includes a first magnet element 141, a first driving coil 142, a second magnet element 143 and a second driving coil 144. The first magnet element 141 is disposed on the rotating portion 130. The first driving coil 142 is disposed on the fixing portion 120, and is configured to generate a driving force with the first magnet element 141. The position detecting unit 150 includes a first detecting magnet 151, a second detecting magnet 152, a first hall element 153 and a second hall element 154. The first detecting magnet 151 is disposed on one of the rotating portion 130 and the fixing portion 120. The second detecting magnet 152 is disposed on one of the rotating portion 130 and the fixing portion 120. The first hall element 153 corresponds to the first detecting magnet 151, and is configured to detect a magnetic field of the first detecting magnet 151. The second hall element 154 corresponds to the second detecting magnet 152, and is configured to detect a magnetic field of the second detecting magnet 152. The first hall element 153 and the second hall element 154 are electrically connected to each other. The position detecting unit 150 has an OR gate function, when any of the first hall element 153 and the second hall element 154 detects the magnetic field, the position detecting unit 150 outputs a position signal S3.

In FIG. 1A, the variable aperture module 100 and the imaging lens assembly 11 can be disposed along an optical axis X. In FIG. 1B, the blade set 110, the fixing portion 120, the rotating portion 130, the flexible printed circuit board 160 and the housing 170 can be disposed along the optical axis X. In FIG. 1B and FIG. 1C, the magnet elements and the driving coils are correspondingly disposed along a direction parallel to the optical axis X. Therefore, it is favorable for minimizing an axial size of the variable aperture module 100. The first magnet element 141 and the second magnet element 143 are driving magnets, and configured for generating a driving force. The first detecting magnet 151 and the second detecting magnet 152 are detecting magnets. It is favorable for reducing the magnetic field interference by separating the driving magnets and the detecting magnets. In the 1st embodiment, a number of the blades 111 is 6, but the present disclosure is not limited thereto.

Please refer to FIG. 1B, FIG. 1D and FIG. 1E. FIG. 1D is a schematic view of the flexible printed circuit board 160 according to the 1st embodiment in FIG. 1A. FIG. 1E is a schematic view of the driving unit 140, the position detecting unit 150, the computing unit 190 and the controlling unit 193 according to the 1st embodiment in FIG. 1A. In FIG. 1D, the first driving coil 142, the second driving coil 144, the first hall element 153 and the second hall element 154 are all disposed on the flexible printed circuit board 160. The driving controlling system of the variable aperture module 100 includes the driving unit 140, the position detecting unit 150, the computing unit 190 and the controlling unit 193. The computing unit 190 includes an amplifier 191 and an analog-to-digital converter 192.

In FIG. 1E, the hall elements (i.e., the first hall element 153 and the second hall element 154) detect the magnetic field of the detecting magnets (i.e., the first detecting magnet 151 and the second detecting magnet 152) to generate a detecting voltage S1. Due to the value of the detecting voltage S1 is small, the detecting voltage S1 is enlarged into an enlarged detecting voltage S2 via the amplifier 191, and then, the enlarged detecting voltage S2 is converted into a digital position signal S3 via the analog-to-digital converter 192. Further, the controlling unit 193 receives the position signal S3 and calculates a target position of the rotating portion 130, and the driving unit 140 drives the rotating portion 130 to rotate to a new target position so as to form a feedback control.

Please refer to FIG. 1F and FIG. 1G. FIG. 1F is a schematic view of the flexible printed circuit board 160 according to the 1st example of the 1st embodiment of the present disclosure. FIG. 1G is a schematic view of the position detecting unit 150 according to the 1st example of the 1st embodiment of the present disclosure.

In FIG. 1F, the same pins of the first hall element 153 and the second hall element 154 can be electrically connected to each other in parallel. In FIG. 1G, each of the hall elements has four pins IN1, IN2, OUT1, OUT2, a set of power input pins IN1, IN2, and a set of signal output pins OUT1, OUT2. The same pins of the first hall element 153 and the second hall element 154 can be electrically connected to each other and output in parallel, when one of the hall elements detects a variation of the magnetic field and the output voltage level turns to low, the entire output voltage becomes low level so as to realize the OR gate function. The position detecting unit 150 can include more than two hall elements, and the position detecting unit 150 can combine and output the position signals S3 of the at least two hall elements.

In other words, the pins IN1 of the first hall element 153 and the second hall element 154 are conductively connected to each other, and conductively connected to a power VCC. The pins IN2 of the first hall element 153 and the second hall element 154 are conductively connected to each other and conductively connected to a ground end GND. The pins OUT1 of the first hall element 153 and the second hall element 154 are conductively connected to each other and conductively connected to the amplifier 191. The pins OUT2 of the first hall element 153 and the second hall element 154 are conductively connected to each other and conductively connected to the amplifier 191.

Please refer to FIG. 1F, FIG. 1G, FIG. 1H and FIG. 1I. FIG. 1H is a schematic view of the flexible printed circuit board 160 according to the 2nd example of the 1st embodiment of the present disclosure. FIG. 1I is a schematic view of the position detecting unit 150 according to the 2nd example of the 1st embodiment of the present disclosure. In FIG. 1I, the pin IN1 of the first hall element 153 is electrically connected to the power VCC, the pin IN2 is connected to the ground end GND, and the pins OUT1, OUT2 are connected to the amplifier 191. The pin IN1 of the second hall element 154 is electrically connected to the power VCC, the pin IN2 is connected to the ground end GND, and the pins OUT1, OUT2 are connected to the amplifier 191.

In FIG. 1F and FIG. 1H, the difference between the 2nd example and the 1st example of the 1st embodiment is the electrically connecting manner between the first hall element 153 and the second hall element 154, other structures and features can be the same or similar to the 1st example, and will not be described again.

In FIG. 1H and FIG. 1I, the first hall element 153 and the second hall element 154 output the detecting voltages S1, respectively, the detecting voltages S1 are transformed into digital position signals S3 via the analog-to-digital converter 192, and the position signals S3 are processed by the controlling unit 193 so as to achieve an OR gate function of the two position signals S3 in a digital signal manner. Otherwise, a logic circuit can be configured in the controlling unit 193 so as to achieve the logic OR gate function by the logic circuit. The logic circuit can be OR gate or other logic gate, but the present disclosure is not limited thereto. Two hall elements are connected to the amplifier 191, and the amplifier 191 can be a buffer so as to avoid a signal conflict between the output signals of the first hall element 153 and the second hall element 154.

### 2nd Embodiment

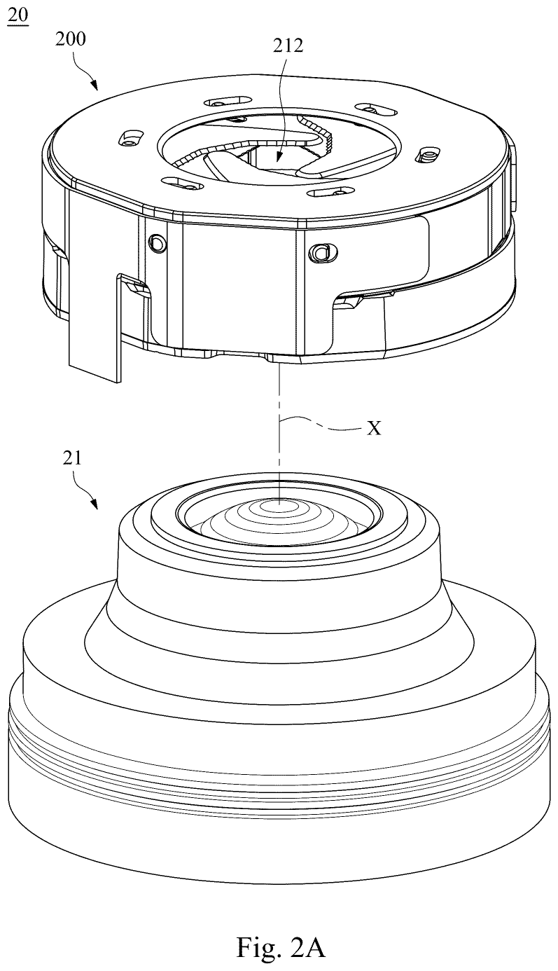

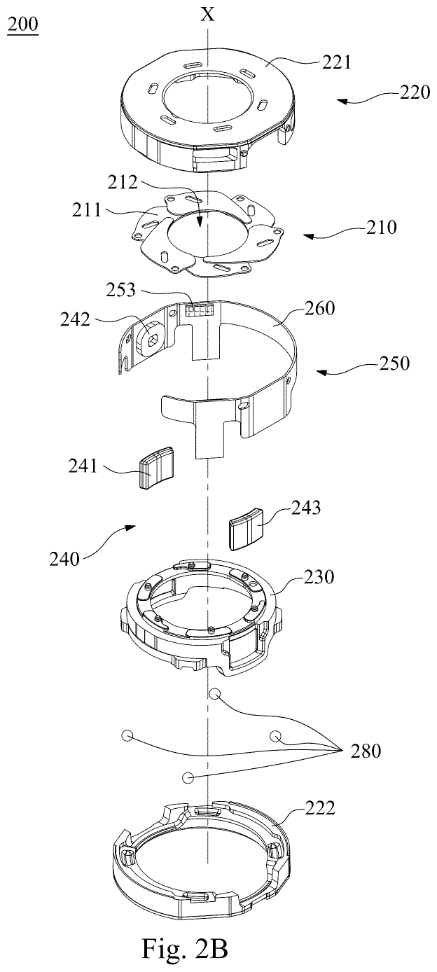

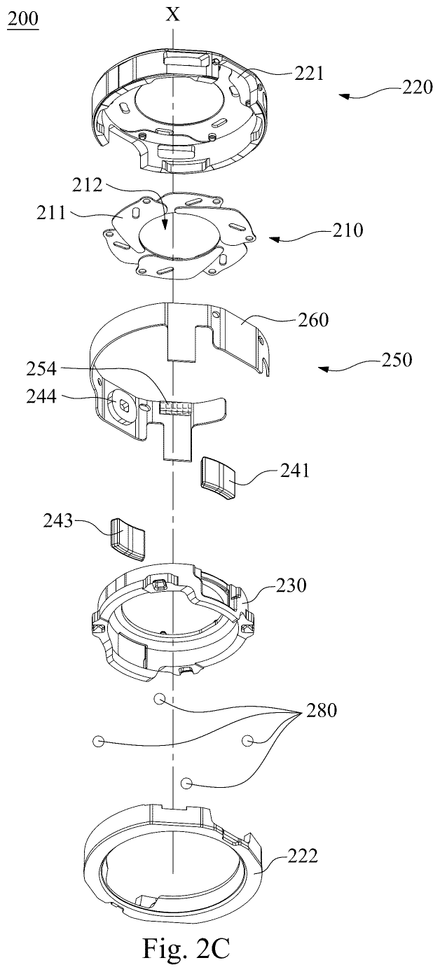

FIG. 2A is a three-dimensional schematic view of an imaging lens assembly module 20 according to the 2nd embodiment of the present disclosure. FIG. 2B is an exploded view of the variable aperture module 200 according to the 2nd embodiment in FIG. 2A. FIG. 2C is another exploded view of the variable aperture module 200 according to the 2nd embodiment in FIG. 2A. The imaging lens assembly module 20 includes a variable aperture module 200 and an imaging lens assembly 21. The variable aperture module 200 includes a blade set 210, a fixing portion 220, a rotating portion 230, a driving unit 240, a position detecting unit 250, a flexible printed circuit board 260 and a rolling element 280. The blade set 210 includes a plurality of blades 211, the blades 211 form a light through hole 212 and a size of the light through hole 212 is adjustable. The fixing portion 220 includes a first fixing element 221 and a second fixing element 222. The rotating portion 230 rotates related to the fixing portion 220, and is for driving each of the blades 211 to rotate related to the fixing portion 220 so as to adjust the size of the light through hole 212. The driving unit 240 is configured for driving the rotating portion 230 to rotate, and includes a first magnet element 241, a first driving coil 242, a second magnet element 243 and a second driving coil 244. The first magnet element 241 is disposed on the rotating portion 230. The first driving coil 242 is disposed on the fixing portion 220, and is configured to generate a driving force with the first magnet element 241. The position detecting unit 250 includes a first hall element 253 and a second hall element 254. The first hall element 253 corresponds to the first magnet element 241, and is configured to detect a magnetic field of the first magnet element 241. The second hall element 254 corresponds to the second magnet element 243, and is configured to detect a magnetic field of the second magnet element 243. The first hall element 253 and the second hall element 254 are electrically connected to each other. The position detecting unit 250 has an OR gate function, when any of the first hall element 253 and the second hall element 254 detects the magnetic field, the position detecting unit 250 outputs a position signal S3.

In FIG. 2B and FIG. 2C, the magnet elements (i.e., the first magnet element 241 and the second magnet element 243) and the driving coils (i.e., the first driving coil 242 and the second driving coil 244) can also be disposed correspondingly along a direction vertical to the optical axis X. Therefore, it is favorable for minimizing the radial direction of the variable aperture module 200. The first magnet element 241 and the second magnet element 243 are disposed on the rotating portion 230. When the first magnet element 241 and the second magnet element 243 are driven by the first driving coil 242 and the second driving coil 244, the first magnet element 241 and the second magnet element 243 are corresponding to the first hall element 253 and the second hall element 254, respectively. Hence, the first magnet element 241 and the second magnet element 243 have a function of driving magnet and a function of detecting magnet at the same time.

The first magnet element 241 and the second magnet element 243 can act as a driving magnet and a detecting magnet at the same time. As long as any one of the first hall element 253 and the second hall element 254 detects a displacement of the magnets, the position signal S3 is outputted to the controlling unit, and the controlling unit computes a new target position, and drives the driving unit 240 to drive the rotating portion 230 rotating to the new target position.

### 3rd Embodiment

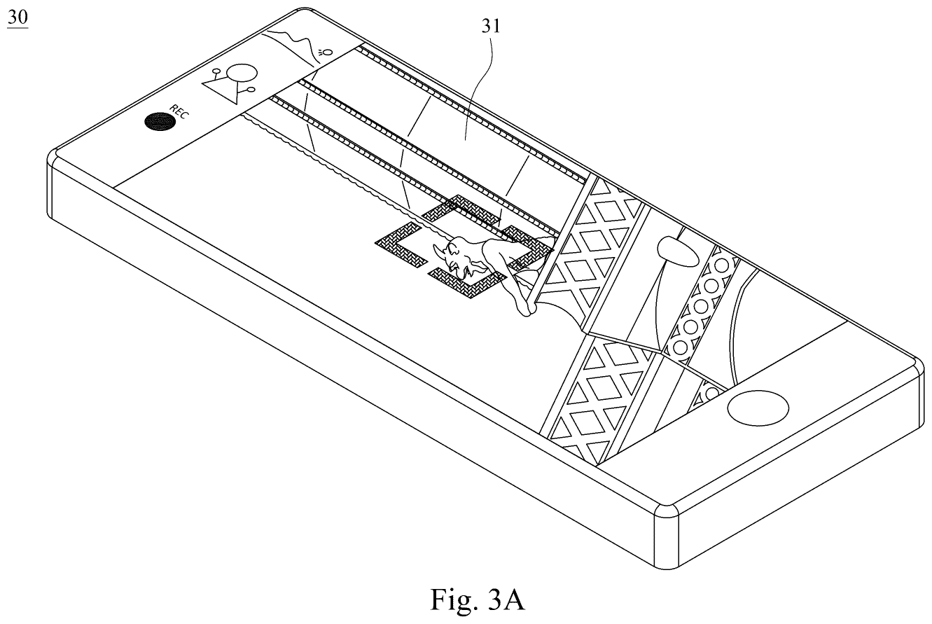

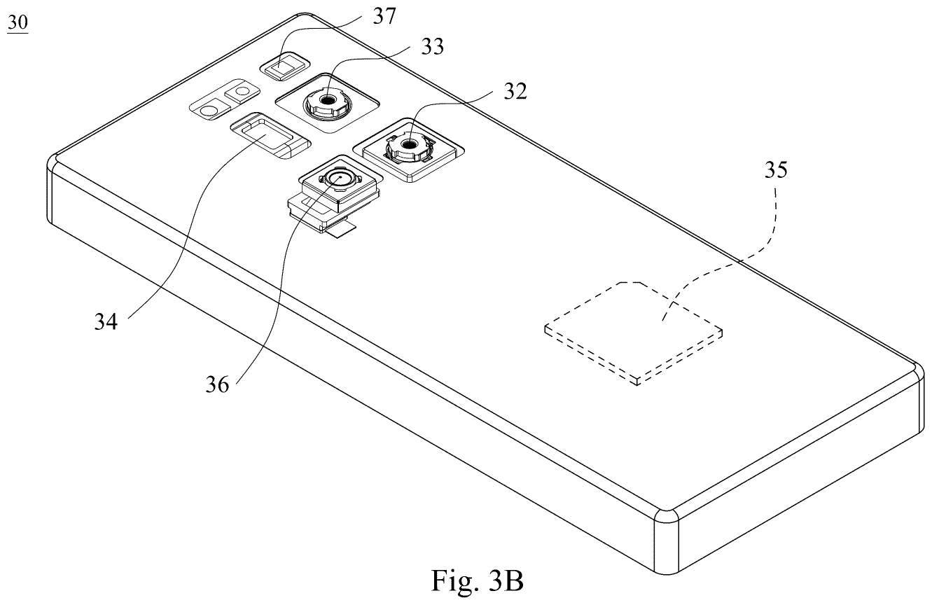

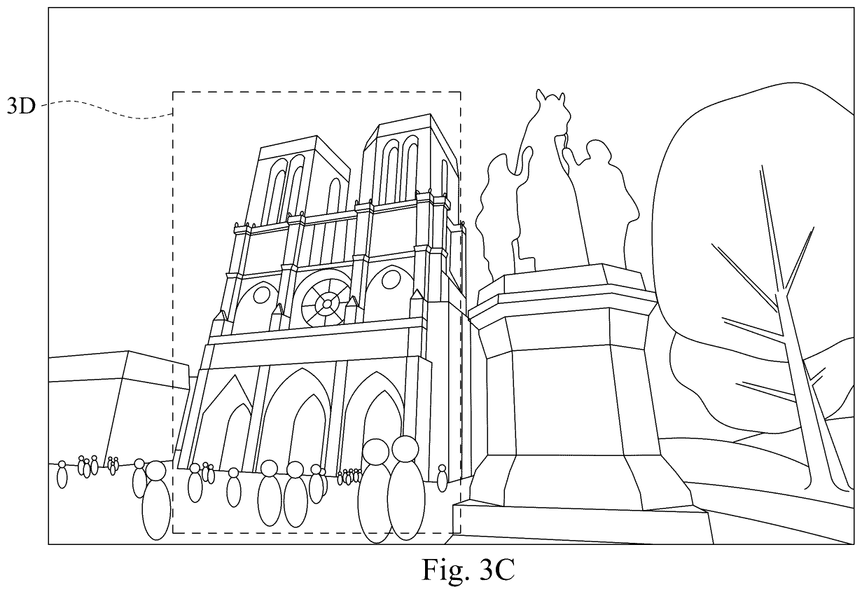

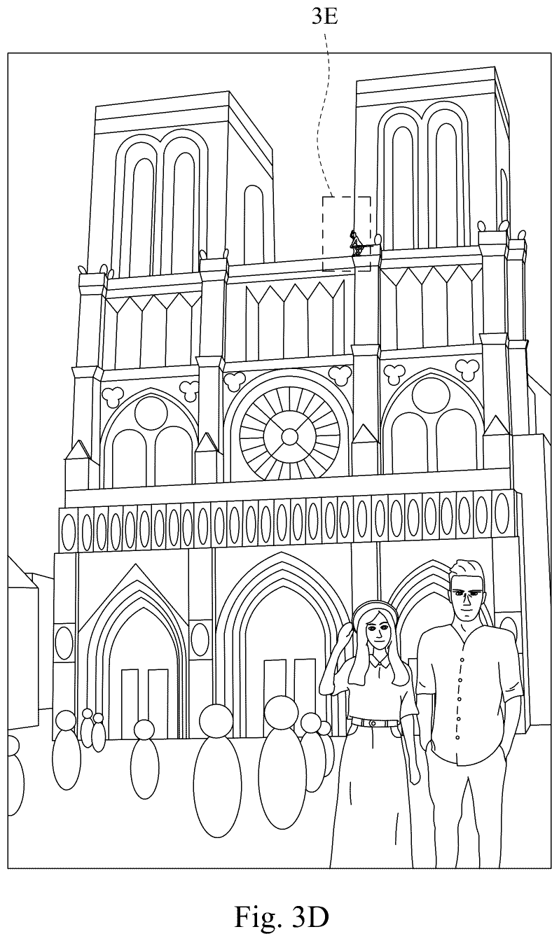

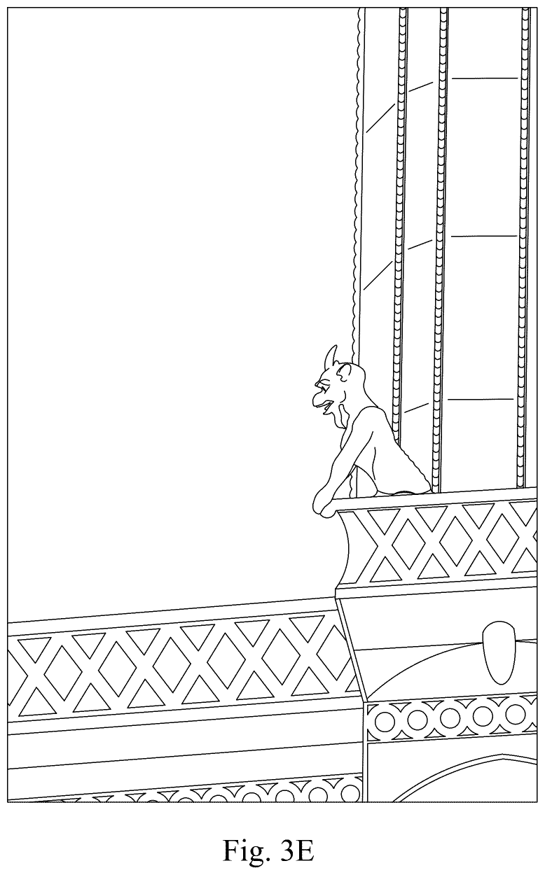

FIG. 3A is a schematic view of an electronic device 30 according to the 3rd embodiment of the present disclosure. FIG. 3B is another schematic view of the electronic device 30 according to the 3rd embodiment in FIG. 3A. In FIG. 3A and FIG. 3B, the electronic device 30 is a smart phone, and includes an imaging lens assembly module and a user interface 31. Moreover, the imaging lens assembly module includes a variable aperture module (not shown) and an imaging lens assembly (not shown), wherein the variable aperture module and the imaging lens assembly are arranged in order from an object side to an image side along the optical axis, and a light enters the imaging lens assembly via the light through hole. Further, the imaging lens assembly module can be an ultra-wide angle imaging lens assembly module 32, a high resolution imaging lens assembly module 33 and telephoto imaging lens assembly modules 34, 36, and the user interface 31 is a touch screen, but the present disclosure is not limited thereto. In particular, the variable aperture module can be one of the variable aperture modules according to the aforementioned 1st embodiment and the 2nd embodiment, but the present disclosure is not limited thereto.

Users enter a shooting mode via the user interface 31, wherein the user interface 31 is configured to display the scene, and the shooting angle can be manually adjusted to switch the ultra-wide angle imaging lens assembly module 32, the high resolution imaging lens assembly module 33 and the telephoto imaging lens assembly modules 34, 36. At this moment, the imaging light is gathered on the image sensor (not shown) via the imaging lens assembly module, and an electronic signal about an image is output to an image signal processor (ISP) 35.

In FIG. 3B, to meet a specification of the electronic device 30, the electronic device 30 can further include an optical anti-shake mechanism (not shown). Furthermore, the electronic device 30 can further include at least one focusing assisting module (its reference numeral is omitted) and at least one sensing element (not shown). The focusing assisting module can be a flash module 37 for compensating a color temperature, an infrared distance measurement component, a laser focus module and so on. The sensing element can have functions for sensing physical momentum and kinetic energy, such as an accelerator, a gyroscope, a Hall Effect Element, to sense shaking or jitters applied by hands of the users or external environments. Accordingly, the imaging lens assembly module of the electronic device 30 is equipped with an auto-focusing mechanism and the optical anti-shake mechanism can be enhanced to achieve the superior image quality. Furthermore, the electronic device 30 according to the present disclosure can have a capturing function with multiple modes, such as taking optimized selfies, high dynamic range (HDR) under a low light condition, 4K resolution recording and so on. Furthermore, the users can visually see a captured image of the camera through the user interface 31 and manually operate the view finding range on the user interface 31 to achieve the autofocus function of what you see is what you get.

Moreover, the imaging lens assembly module, the optical anti-shake mechanism, the sensing element and the focusing assisting module can be disposed on a flexible printed circuit board (FPC) (not shown) and electrically connected to the associated components, such as the image signal processor 35, via a connector (not shown) to perform a capturing process. Since the current electronic devices, such as smart phones, have a tendency of being compact, the way of firstly disposing the imaging lens assembly module and related components on the flexible printed circuit board and secondly integrating the circuit thereof into the main board of the electronic device via the connector can satisfy the requirements of the mechanical design and the circuit layout of the limited space inside the electronic device, and obtain more margins. The autofocus function of the imaging lens assembly module can also be controlled more flexibly via the touch screen of the electronic device. According to the 3rd embodiment, the electronic device 30 can include a plurality of sensing elements and a plurality of focusing assisting modules. The sensing elements and the focusing assisting modules are disposed on the flexible printed circuit board and at least one other flexible printed circuit board (not shown) and electrically connected to the associated components, such as the image signal processor 35, via corresponding connectors to perform the capturing process. In other embodiments (not shown herein), the sensing elements and the focusing assisting modules can also be disposed on the main board of the electronic device or carrier boards of other types according to requirements of the mechanical design and the circuit layout.

Furthermore, the electronic device 30 can further include, but not be limited to, a display, a control unit, a storage unit, a random access memory (RAM), a read-only memory (ROM), or the combination thereof.

FIG. 3C is a schematic view of an image captured via the electronic device 30 according to the 3rd embodiment in FIG. 3A. In FIG. 3C, the larger range of the image can be captured via the ultra-wide angle imaging lens assembly module 32, and the ultra-wide angle imaging lens assembly module 32 has the function of accommodating wider range of the scene.

FIG. 3D is another schematic view of an image captured via the electronic device 30 according to the 3rd embodiment in FIG. 3A. In FIG. 3D, the image of the certain range with the high resolution can be captured via the high resolution imaging lens assembly module 33, and the high resolution imaging lens assembly module 33 has the function of the high resolution and the low deformation.

FIG. 3E is still another schematic view of an image captured via the electronic device 30 according to the 3rd embodiment in FIG. 3A. In FIG. 3E, the telephoto imaging lens assembly module 34 has the enlarging function of the high magnification, and the distant image can be captured and enlarged with high magnification via the telephoto imaging lens assembly module 34.

As shown in FIG. 3C to FIG. 3E, the zooming function can be obtained via the electronic device 30, when the scene is captured via the imaging lens assembly module with different focal lengths cooperated with the function of image processing.

### 4th Embodiment

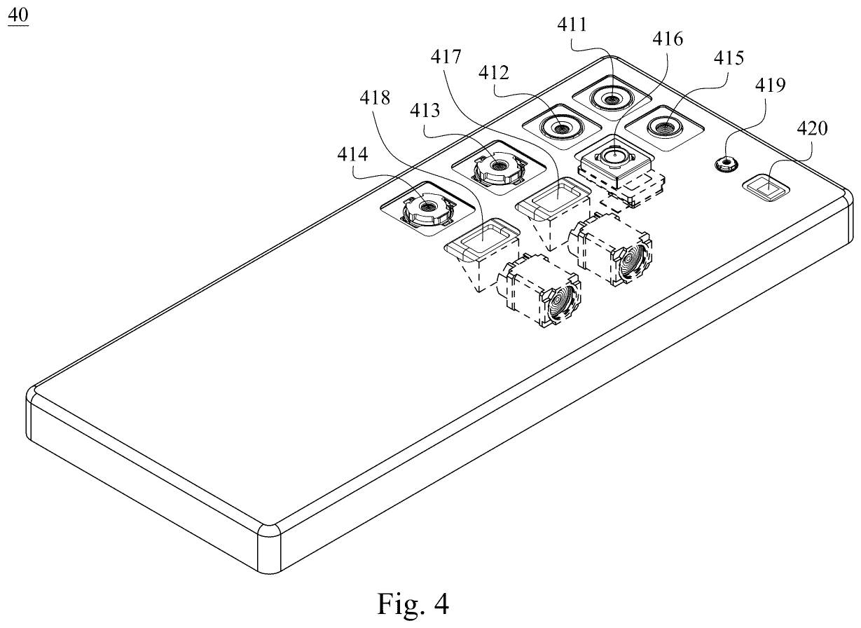

FIG. 4 is a schematic view of an electronic device 40 according to the 4th embodiment of the present disclosure. In FIG. 4, the electronic device 40 is a smart phone, and includes an imaging lens assembly module, and the imaging lens assembly module includes a variable aperture module (not shown) and an imaging lens assembly (not shown), wherein the variable aperture module and the imaging lens assembly are arranged in order from an object side to an image side along the optical axis, and a light enters the imaging lens assembly via the light through hole. Moreover, the imaging lens assembly module can be one of ultra-wide angle imaging lens assembly modules 411, 412, wide angle imaging lens assembly modules 413, 414, telephoto imaging lens assembly modules 415, 416, 417, 418 and a Time-Of-Flight (TOF) module 419. The TOF module 419 can be another type of the imaging lens assembly module, and the disposition is not limited thereto. In particular, the variable aperture module can be one of the variable aperture modules according to the aforementioned 1st embodiment to the 2nd embodiment, but the present disclosure is not limited thereto.

Further, the telephoto imaging lens assembly modules 417, 418 are configured to fold the light, but the present disclosure is not limited thereto.

To meet a specification of the electronic device 40, the electronic device 40 can further include an optical anti-shake mechanism (not shown). Furthermore, the electronic device 40 can further include at least one focusing assisting module (not shown) and at least one sensing element (not shown). The focusing assisting module can be a flash module 420 for compensating a color temperature, an infrared distance measurement component, a laser focus module and so on. The sensing element can have functions for sensing physical momentum and kinetic energy, such as an accelerator, a gyroscope, a Hall Effect Element, to sense shaking or jitters applied by hands of the users or external environments. Accordingly, the imaging lens assembly module of the electronic device 40 is equipped with an auto-focusing mechanism and the optical anti-shake mechanism can be enhanced to achieve the superior image quality. Furthermore, the electronic device 40 according to the present disclosure can have a capturing function with multiple modes, such as taking optimized selfies, High Dynamic Range (HDR) under a low light condition, 4K resolution recording and so on.

Further, all of other structures and dispositions according to the 4th embodiment are the same as the structures and the dispositions according to the 3rd embodiment, and will not be described again herein.

The foregoing description, for purpose of explanation, has been described with reference to specific embodiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A variable aperture module, comprising:
a blade set comprising a plurality of blades, wherein the blades form a light through hole and a size of the light through hole is adjustable;
a fixing portion;
a rotating portion rotating related to the fixing portion, and for driving each of the blades to rotate related to the fixing portion so as to adjust the size of the light through hole;
a driving unit configured for driving the rotating portion to rotate, and comprising:
a first magnet element disposed on one of the rotating portion and the fixing portion; and
a first driving coil disposed on the other one of the rotating portion and the fixing portion, and configured to generate a driving force with the first magnet element; and
a position detecting unit, comprising:
a first detecting magnet disposed on one of the rotating portion and the fixing portion;
a second detecting magnet disposed on one of the rotating portion and the fixing portion;
a first hall element corresponding to the first detecting magnet, and configured to detect a magnetic field of the first detecting magnet; and
a second hall element corresponding to the second detecting magnet, and configured to detect a magnetic field of the second detecting magnet;
wherein the first hall element and the second hall element are electrically connected to each other, and the position detecting unit has an OR gate function, when any of the first hall element and the second hall element detects the magnetic field, the position detecting unit outputs a position signal.

2. The variable aperture module of claim 1, wherein the first hall element and the second hall element are connected in parallel.

3. The variable aperture module of claim 1, wherein the first detecting magnet and the second detecting magnet are disposed circular symmetrically.

4. The variable aperture module of claim 1, wherein the first hall element and the second hall element are disposed circular symmetrically.

5. The variable aperture module of claim 1, wherein the variable aperture module further comprises a flexible printed circuit board, the first driving coil is disposed on the other one of the fixing portion and the rotating portion via the flexible printed circuit board, and the flexible printed circuit board supplies power to the first driving coil, the first hall element and the second hall element simultaneously.

6. A variable aperture module, comprising:
a blade set comprising a plurality of blades, wherein the blades form a light through hole and a size of the light through hole is adjustable;
a fixing portion;
a rotating portion rotating related to the fixing portion, and for driving each of the blades to rotate related to the fixing portion so as to adjust the size of the light through hole;
a driving unit configured for driving the rotating portion to rotate, and comprising:
a first magnet element disposed on one of the rotating portion and the fixing portion; and
a first driving coil disposed on the other one of the rotating portion and the fixing portion, and configured to generate a driving force with the first magnet element;
a position detecting unit, comprising:
a first detecting magnet disposed on one of the rotating portion and the fixing portion;
a second detecting magnet disposed on one of the rotating portion and the fixing portion;
a first hall element corresponding to the first detecting magnet, and configured to detect a magnetic field of the first detecting magnet; and
a second hall element corresponding to the second detecting magnet, and configured to detect a magnetic field of the second detecting magnet; and
a controlling unit receiving a position signal from the first hall element and a position signal from the second hall element;
wherein when any of the first hall element and the second hall element detects the magnetic field, each of the first hall element and the second hall element outputs each of the position signals to the controlling unit, and each of the position signals is calculated via an OR gate function of the controlling unit to generate a position information.

7. The variable aperture module of claim 6, wherein the first detecting magnet and the second detecting magnet are disposed circular symmetrically.

8. The variable aperture module of claim 6, wherein the first hall element and the second hall element are disposed circular symmetrically.

9. The variable aperture module of claim 6, wherein the variable aperture module further comprises a flexible printed circuit board, the first driving coil is disposed on the other one of the fixing portion and the rotating portion via the flexible printed circuit board, and the flexible printed circuit board supplies power to the first driving coil, the first hall element and the second hall element simultaneously.

10. A variable aperture module, comprising:
a blade set comprising a plurality of blades, wherein the blades form a light through hole and a size of the light through hole is adjustable;
a fixing portion;
a rotating portion rotating related to the fixing portion, and for driving each of the blades to rotate related to the fixing portion so as to adjust the size of the light through hole;
a driving unit configured for driving the rotating portion to rotate, and comprising:
a first magnet element disposed on one of the rotating portion and the fixing portion;
a second magnet element disposed on one of the rotating portion and the fixing portion;
a first driving coil disposed on the other one of the rotating portion and the fixing portion, and configured to generate a driving force with the first magnet element; and
a second driving coil disposed on the other one of the rotating portion and the fixing portion, and configured to generate a driving force with the second magnet element; and
a position detecting unit, comprising:
a first hall element corresponding to the first magnet element, and configured to detect a magnetic field of the first magnet element; and
a second hall element corresponding to the second magnet element, and configured to detect a magnetic field of the second magnet element;
wherein the first hall element and the second hall element are electrically connected to each other, and the position detecting unit has an OR gate function, when any of the first hall element and the second hall element detects the magnetic field, the position detecting unit outputs a position signal.

11. The variable aperture module of claim 10, wherein the first hall element and the second hall element are connected in parallel.

12. The variable aperture module of claim 10, wherein the first magnet element and the second magnet element are disposed circular symmetrically, and the first driving coil and the second driving coil are disposed circular symmetrically.

13. The variable aperture module of claim 10, wherein the first driving coil and the second driving coil provide a rotating torque for the rotating portion.

14. The variable aperture module of claim 10, wherein the first hall element and the second hall element are disposed circular symmetrically.

15. The variable aperture module of claim 10, wherein the variable aperture module further comprises a flexible printed circuit board, the first driving coil is disposed on the other one of the fixing portion and the rotating portion via the flexible printed circuit board, and the flexible printed circuit board supplies power to the first driving coil, the second driving coil, the first hall element and the second hall element simultaneously.

16. A variable aperture module, comprising:
a blade set comprising a plurality of blades, wherein the blades form a light through hole and a size of the light through hole is adjustable;
a fixing portion;
a rotating portion rotating related to the fixing portion, and for driving each of the blades to rotate related to the fixing portion so as to adjust the size of the light through hole;
a driving unit configured for driving the rotating portion to rotate, and comprising:
a first magnet element disposed on one of the rotating portion and the fixing portion;
a second magnet element disposed on one of the rotating portion and the fixing portion;
a first driving coil disposed on the other one of the rotating portion and the fixing portion, and configured to generate a driving force with the first magnet element; and
a second driving coil disposed on the other one of the rotating portion and the fixing portion, and configured to generate a driving force with the second magnet element;
a position detecting unit, comprising:
a first hall element corresponding to the first magnet element, and configured to detect a magnetic field of the first magnet element; and
a second hall element corresponding to the second magnet element, and configured to detect a magnetic field of the second magnet element; and
a controlling unit receiving a position signal from the first hall element and a position signal from the second hall element;
wherein when any of the first hall element and the second hall element detects the magnetic field, each of the first hall element and the second hall element outputs each of the position signals to the controlling unit, and each of the position signals is calculated via an OR gate function of the controlling unit to generate a position information.

17. The variable aperture module of claim 16, wherein the first magnet element and the second magnet element are disposed circular symmetrically, and the first driving coil and the second driving coil are disposed circular symmetrically.

18. The variable aperture module of claim 16, wherein the first driving coil and the second driving coil provide a rotating torque for the rotating portion.

19. The variable aperture module of claim 16, wherein the first hall element and the second hall element are disposed circular symmetrically.

20. The variable aperture module of claim 10, wherein the variable aperture module further comprises a flexible printed circuit board, the first driving coil is disposed on the other one of the fixing portion and the rotating portion via the flexible printed circuit board, and the flexible printed circuit board supplies power to the first driving coil, the second driving coil, the first hall element and the second hall element simultaneously.

21. An imaging lens assembly module, comprising:
the variable aperture module of claim 16.

22. An electronic device, comprising:
the imaging lens assembly module of claim 21.
